(19) United States
(12) Patent Application Publication
(10) Pub. No.: US 2023/0019394 A1
(43) Pub. Date: Jan. 19, 2023

(54) Comtool Communication System

(71) Applicant: Prozindu, LLC, Silver Spring, MD (US)

(72) Inventor: James Kirunda Kakaire, Silver Spring, MD (US)

(73) Assignee: Prozindu, LLC, SILVER SPRING, MD (US)

(21) Appl. No.: 17/935,100

(22) Filed: Sep. 24, 2022

Related U.S. Application Data
(60) Provisional application No. 63/002,865, filed on Mar. 31, 2020.

(51) Int. Cl. H04N 21/442; H04N 21/4786; H04N 21/472; H04N 21/422

(52) U.S. Cl. CPC H04N 21/44226; H04N 21/4786; H04N 21/47217; H04N 21/42204

(57) ABSTRACT

A system that simplifies electronic communication and data sharing by integrating various apps into one. The COMTOOL communication system is characterized by a color coded user ID as a security feature for preventing imposters in a user's contacts to reduce fake news distribution. The system integrates a photo album, a calendar, a voice over IP, a video chart, a video playback, a religious and political group's app and a forum app into one interface and makes them available as a mobile application on a mobile phone, a web based application hosted on a server and as an application installed in television sets. A television remote control is designed to transmit data to a television lens for pausing, rewinding and forwarding a video in playback mode. Double pressing a selector button on a television remote control subscribes to a content provider channel.

### RELATED APPLICATIONS

This application claims the benefit of U.S. Provisional Application No. 63/002,865 filed Mar. 31, 2020 entitled “Comtool,” the disclosure of which is incorporated herein by reference in its entirety for all purposes. The application was designed in 2015 but filed provisionally in 2017 and accorded a PCT S/N PCT/2018/067,426 the priority of which is void.

### FIELD OF DISCLOSURE

The present disclosure generally relates to communication systems employed to control, disseminate, and interact with information via user interfaces, software applications, databases and files.

### BACKGROUND OF THE DISCLOSURE

Now more than ever, businesses, people, homes, and organizations need to keep communication channels open and accessible. Email applications alone may not be suitable to rely on as a sole means of communication, as today's fast-moving applications require modern, robust, and complex communication software as a means to boost productivity and problem-solving. With communication tools such as group chat, video conferencing, screen sharing, and productivity tools becoming ubiquitous, it may be desirable to provide a communication software apps that connects people in a seamless and integrated way.

### BRIEF OVERVIEW

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an example of a main interface of the COMTOOL communication system that can be displayed after authentication to the system, where the main interface displays functionality of the system and various software applications (apps), according to one or more embodiments shown and described herein.

FIG. 2 illustrates an example of a “Settings” user interface (UI) of the COMTOOL communication system employed for users to configure settings of the various apps shown in FIG. 1, the Settings UI includes a “MyAccount” tab that provides an admin menu for commercial accounts, according to one or more embodiments shown and described herein.

FIG. 3 illustrates an example of a “Send Message” UI of the COMTOOL communication system employed for users to send messages, the Send Message UI can be displayed in response to a user selecting a “Send Message” button of the main interface shown in FIG. 1, according to one or more embodiments shown and described herein.

FIG. 4 illustrates an example of a “Contacts” UI of the of the COMTOOL communication system employed for depicting the various contacts associated with a user, the Contacts UI can be displayed in response to a user selecting a “Contacts” button of the main interface shown in FIG. 1, according to one or more embodiments shown and described herein.

FIG. 5 illustrates an example of a “Forums” UI of the COMTOOL communication system employed for depicting a listing of the various forums that can be accessed by a user, the Forums UI can be display in response to a user selecting a “My Forums” button of the main interface shown in FIG. 1, according to one or more embodiments shown and described herein.

FIG. 6 illustrates an example of a “Request ForumMembership” UI of the COMTOOL communication system employed for a user to request membership to forum(s) to gain access, Request ForumMembership UI can be display in response to a user selecting a “Request Forum Access” button of the main interface shown in FIG. 1, according to one or more embodiments shown and described herein.

FIG. 7 illustrates an example of a “Social Media Share” UI of the COMTOOL communication system employed for a user to share data, such as posts or messages, to various social media platforms, such as Facebook™, Twitter™, Linked In™, Google™+ and others, the Social Media Share UI can be display in response to a user selecting a “Share Social Media” button of the main interface shown in FIG. 1, according to one or more embodiments shown and described herein.

FIG. 8 illustrates an example of an “Accept/Deny User Account Request” UI of the COMTOOL communication system employed for a user to add user account request(s) to a group or the user's account, according to one or more embodiments shown and described herein.

FIG. 9 illustrates an example of a “Manually Add Contacts” UI of the COMTOOL communication system employed for a user to manually add contact(s) manually to a group or the user's account, according to one or more embodiments shown and described herein.

FIG. 10 illustrates an example of a “Television Remote Control” UI of the COMTOOL communication system employed for a user to select rewind, forward and pause functions for videos in playback mode on a television screen, according to one or more embodiments shown and described herein.

FIG. 11 illustrates an example of a “Television” UI of the COMTOOL communication system employed for rewinding, forwarding and pausing a video in playback mode on a television screen utilizing the television remote control UI shown in FIG. 10, according to one or more embodiments shown and described herein.

FIG. 12 illustrates an example of a universal circuit board employed for executing instructions issued to a processor of a television, computer, tablet or mobile computing device (e.g., smartphone) implementing the COMTOOL communication system, according to one or more embodiments shown and described herein.

FIG. 13 depicts an example of a method implemented by the COMTOOL communication system for creating an account, authenticating users and managing the account which includes adding user account requests, deleting users from the account or group and displaying videos for non-subscribers, according to one or more embodiments shown and described herein.

FIG. 14 depicts an example of a method implemented by the COMTOOL communication system for displaying applications to interface with users and executing the various user interfaces and independent apps, according to one or more embodiments shown and described herein.

FIG. 15 depicts an example of an entity relationship (ER) model representing a model of a partial database system of the COMTOOL communication system, the database system employed for storing data of users of the COMTOOL communication system, according to one or more embodiments shown and described herein.

FIG. 16 depicts an example of a database schematic model representing the ER Model shown in FIG. 15, the database schematic model showing primary entities and associated attributes of the database system of the COMTOOL communication system, according to one or more embodiments shown and described herein.

FIG. 17 depicts an example of a method implemented by the COMTOOL communication system for executing an app for a group on the system, for example a Religious Group and a Political Group, according to one or more embodiments shown and described herein.

FIG. 18 depicts an example of a computer system that may be used in implementing the COMTOOL communication system, according to one or more embodiments shown and described herein.

### DETAILED DESCRIPTION OF THE DISCLOSURE

The present disclosure includes many aspects and features. Moreover, while many aspects and features relate to, and are described in, the context of communication systems, embodiments of the present disclosure are not limited to use only in this context. The present disclosure can be understood more readily by reference to the following detailed description of the disclosure and the Examples included therein.

Before the present articles, systems, apparatuses, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings. As used in the specification and the appended claims, the term “all” can include referents to at least one or more unless the context clearly dictates otherwise. Thus, for example, reference to “all” contents can include one or more contents unless there are no contents in which “all” would mean none in this particular context. Therefore all can mean one or more, none, or all as is generally understood.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed apparatuses, systems, and articles of the disclosure as well as the apparatuses themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and apparatuses of the disclosure. Thus, if there are a variety of additional steps that can be performed it is understood that each of these additional steps can be performed with any specific aspect or combination of aspects of the methods of the disclosure.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

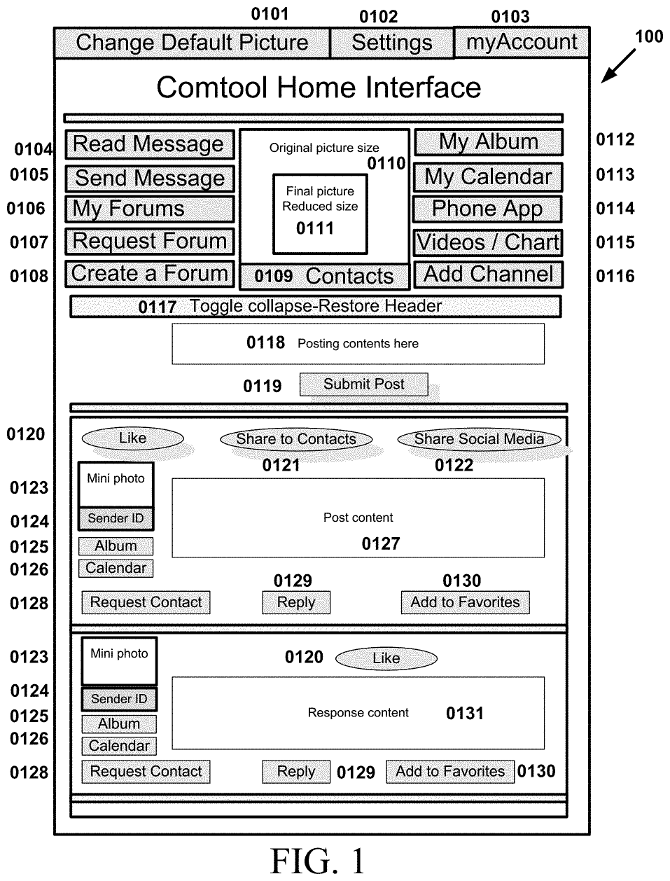

With reference now to the drawings, and in particular FIG. 1 through FIG. 18 thereof, examples of the COMTOOL communication system and the principles and concepts thereof will be described.

As disclosed herein, the COMTOOL communication system can be implemented as a system, including software and hardware aspects, that simplifies the electronic communication process by facilitating and controlling operation of multiple communication software applications (apps) and personal apps that share content. These apps supported by the COMTOOL communication system are comprised of: a messaging app; contacts that are shared by multiple apps; forums; photo album; a calendar; a phone app; a video chart; and a video playback app. Furthermore, in some embodiments, the COMTOOL communication system is installable as a software application as an app in mobile computing devices (e.g., smartphone) and a webapp accessible from browsers on computers (e.g., desktop computers), tablets and television sets.

The COMTOOL communication system can be configured to save transaction data on servers. The COMTOOL communication system has other capabilities, such as allowing users to store their data and subsequently share that data external to the system, for instance to social media platforms of different kinds via hypertext transfer protocol (HTTP) links. Data from the COMTOOL communication system can be accessible over a web-based interface utilizing any device having network connectivity, such as a mobile computing device connected to the Internet. In some embodiments, user identifiers (IDs) are color coded by the COMTOOL communication system as a means for preventing imposters from creating new accounts (or names) that are synonymous to existing accounts, hence ensuring security from potential breaches of the system to be used for malicious actions. For example, color coding can prevent a hacker from utilizing names that are synonymous to names (already having existing accounts on the system) to post under the guise of an existing user. As an example, the COMTOOL communication system can be configured to display names IDs (e.g., first instance of the name ID) one color, but secondary name IDs that seem very similar to existing name IDs (e.g., second or more instance of the name ID) are given a different color. Thus, the COMTOOL communication system has the ability to filter fake postings, for example posts from secondary name IDs (e.g., in the different color). Moreover, users of the COMTOOL communication system may be required to describe graphics to be posted and type of content in the graphics so as to control misinformation.

The COMTOOL communication system provides a platform for users to communicate utilizing multiple applications from one system. It provides users with ability to authorize contacts to specific applications including a photo album app, a calendar app, a software based phone app over IP, a video chart app and a video playback app. Users of these apps have to be authorized by the owner individually by placing them in user groups in order to have access.

In addition, the COMTOOL communication system can support collaborative functions. For example, the COMTOOL communication system enables a group of individuals working on a project to communicate (e.g., one-on-one, one-to-many, or many-to-many) on the same topic. During collaborations, users can employ the COMTOOL communication system to access (e.g., read) and interact with messages or posts from other users, with ability to respond to communications and video chart aspects of the collaboration.

As alluded to above, the COMTOOL communication system can be implemented on mobile computing devices (smartphones, tablets) as an app including mobile interface(s) particularly designed for use on mobile computing devices associated with smaller dimensions, smaller screens, and limited capabilities. Also, the COMTOOL communication system can be implemented on primarily stationary computers (e.g., desktop computers) connected to servers through network connection (e.g., Internet) utilizing web interface(s) particularly designed for use on computer devices associated with larger dimensions, larger screens, and greater resources. The COMTOOL communication system can be implemented on other devices having visual display and processing capabilities, for example television sets with operating systems. In this embodiment, the COMTOOL communication system can be installed on a television to function in a similar manner to a remote control device.

As described herein, the COMTOOL communication system can include several user interfaces (UI). A UI of the COMTOOL communication system can be employed to transmit instructions to a processor the computing device in which the system is executing, and invokes processes, functions, and other interfaces of the COMTOOL communication system that are installed in memory of the computing device. The UIs of the COMTOOL communication system can also be configured to wirelessly transmit instructions to a server, and subsequently retrieve data pertaining to content provider channels, wherein a user can add particular channels of interest to a channel list in the app and sorts the channels by category and country. Accordingly, the UIs of the COMTOOL communication system can be considered a data-driven system, as the system supports interactions with database-driven apps.

Further, the COMTOOL communication system offers internal messaging communication. The internal messaging has the capability to receive messages from external email clients, and send messages to external email clients, for instance by automatically reading email addresses from the contacts or email addressed manually entered by the user (e.g., directly typed in). The internal messaging feature of the system has multiple real-world applications that increases the ease of communicating with various types of users. As an example, when non-office employees are out on different floors or different buildings, a supervisor can easily pass messages through the internal messaging feature of the COMTOOL communication system. Thus, all employees on that particular project can read and write to communicate what is going on at their current location. The internal messaging feature utilizes multiple database entities including forums, threads, languages and posts coupled to the users' messages entity to facilitate the communication between different users and groups across platforms, such as mobile phones and tablets.

Also, the COMTOOL communication system, as disclosed, includes various forum features. For example, the COMTOOL communication system can include a UI that allows users to create forums and request access to other existing forums. In some embodiments, the forums are sorted by category and/or country in interactions supported by the COMTOOL communication system.

The COMTOOL communication system implements several apps, as previously described. Users can access these multiple apps of the system from a centralized location. That is, the system can have a main interface (e.g., COMTOOL home interface) that presents several interactive buttons, where each button corresponds to a particular app. Thus, when a user selects a button on the main interface, that button serves as a link to the respective app (and its UIs). In some embodiments, order for any person to have access to the apps of the COMTOOL communication system, that person must be added as a user to a user group controlled by the account owner. As an example, the system wouldn't permit a person to have access to another person's photo album without being added to the album user group. In other words, a user may be provided access to one app of the COMTOOL communication system, without necessarily having access to the others apps the COMTOOL communication system.

Referring now to FIG. 1, an example of the main interface 100 (e.g., COMTOOL home interface) implemented by the COMTOOL communication system is shown. The main interface 100 can be implement as a graphical user interface (GUI), user experience (UX), or any suitable interface that supports interactive components (e.g., buttons, lines, data entry fields) that enables a user to utilize the various capabilities of the COMTOOL communication system. For example, a computing device, such as a smartphone or tablet, can include one or more apps for implementing the COMTOOL communication system installed thereon. The main interface 100 may be the initial UI launched on the screen of a computing device, in response to a user initially opening the app to access the COMTOOL communication system.

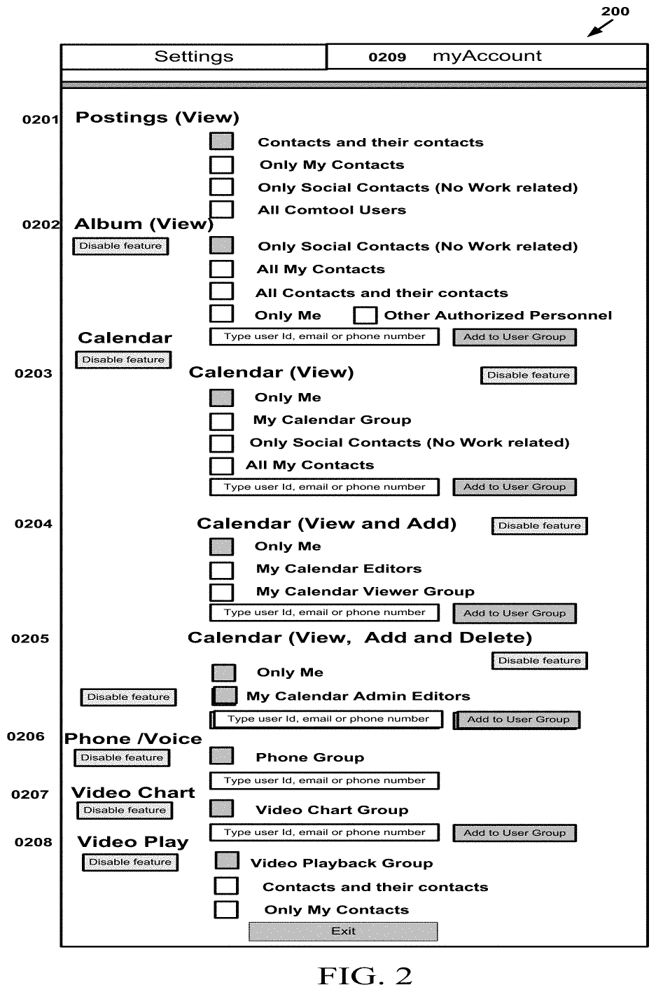

Examples of additional UIs that can be implemented as elements of the COMTOOL communication system are also illustrated in FIG. 2-FIG. 11. According to the embodiments, the main interface 100 is considered the “main” or home UI, as it serves as a centralized location that allows a user to easily access and/or navigate to any of the other UIs supported by the COMTOOL communication system. It should be understood that the UIs illustrated herein are merely exemplary and are not intended to be limiting. Accordingly, the COMTOOL communication system, as disclosed herein, can support other UIs and/or features that are not illustrated in FIG. 1-FIG. 11. Particularly, in the illustrated example, the main interface 100 includes a plurality of buttons 0101-0130, where each of the buttons 0101-0130 serve as a clickable link that launches a corresponding UI of the COMTOOL communication system respectively, when selected by the user. Alternatively, in some embodiments, an initial interface of the COMTOOL communication system is a login UI (not shown). The login UI provides a user with a login screen with a button link for creating an account, a text field to enter email or phone number to log into the system, a text field for a password and a button link to submit the collected data. The login UI can also provide a designated window on top where advertisements are placed in form of text, video or audio on mobile phones and tablets, which serves a mechanism that allows the COMTOOL communication system to generate marketing-based revenue.

As seen in FIG. 1, the main interface 100 includes a “Change Default Picture” button 0101. During operation, a user may press the “Change Default Picture” button 0101 arranged at the top left on the main interface 100 in order to select a picture (e.g., visual or graphic file) that is associated with the user's account within the COMTOOL communication system. Preferably, the user's default picture is a picture that can be used by the COMTOOL communication system and other users of the system to identify the person in which the account belongs to, such as a facial photograph. Selecting the “Change Default Picture” can opens the user's photo album and display all the pictures the user has. Subsequently, the user touches or clicks one picture and confirms to set it as the default picture that is associated with their account, and according first displays when an app of the COMTOOL communication system is launched. In the event the album is empty, the application displays a default picture.

Also, FIG. 1 shows that the main interface 100 can include a “Settings” button 01012 on the top menu of the UI. The “Settings” button 01012 enables a user to configure, or otherwise determine the settings for, the independent applications of the COMTOOL communication system. A “Settings” UI that is presented in response to a user pressing the “Settings” button 01012 is prominently illustrated in FIG. 2. A “myAccount” button 0103 is also shown to be include in the top menu of the main interface 100. The “myAccount” button 0103 can be configured to provide a drop down menu, in response to being selected by the user. This drop down menu that launches from the “myAccount” button 0103 can include logon option if the app is being access via a browser (as opposed to a mobile app), for instance when the app for accessing the COMTOOL communication system is on a desktop computer. The drop down menu that launches from the “myAccount” button 0103 can also include an admin menu for commercial accounts. The admin menu adds, disables and deletes users, uploads content and edits a financial account. Financial setup and edits include, but are not limited to, change of payment methods such as direct deposit to a bank account, electronic check, pre-paid debit cards and location pickup. Where applicable, users can also set and change tax information and personal data such as address, email, and phone number. The COMTOOL communication system can be configured to save changes to the user's data to database system (e.g., external to the computing device executing the app) or in a local memory (e.g., internal to the computing device executing the app).

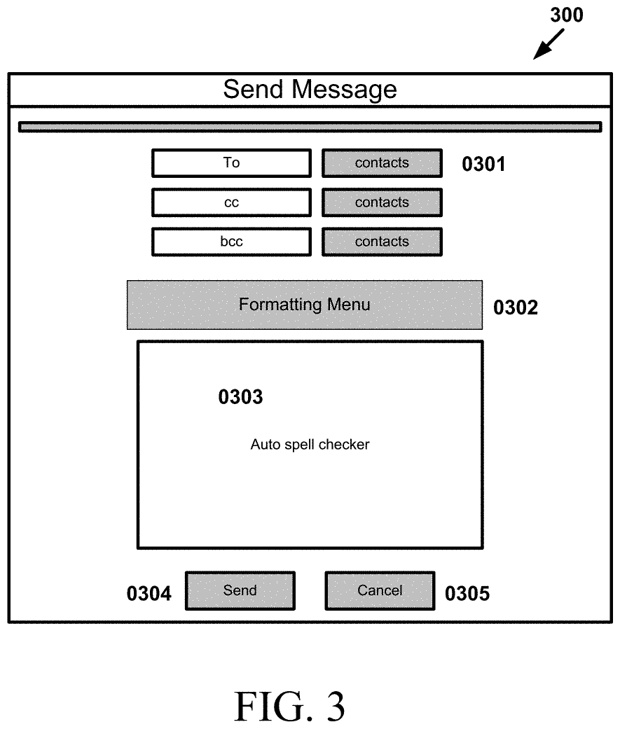

The illustrated example shows that the main interface 100 also includes a “Messages” button 0104. The Messages button 0104 can be selected to by the user to launch an UI that accesses and displays any available messages (e.g., email, SMS, IM, chat, and the like) associated with the user's account in the COMTOOL communication system. For example, the user pressing the Messages 0104 button opens a UI listing of electronic messages to read. Additionally, the main interface 100 includes a “SendMessage” button 0105. The Send Message button 0105 can be configured to invoke the “Send Message” UI that is prominently shown in FIG. 3, in response to being clicked by the user. The Send Message UI can then be employed to send messages to contacts or any ID typed into the address bar via the COMTOOL communication system.

The “My Forums” button 0106 on the main interface 100 can provide a listing of all the forums the user has access to. These forums are ordered by category and/or by country in the various applications of the COMTOOL communication system. The forums can further support additional features, such as streaming live charts and videos. These streams can be access in real-time, or saved to servers for later access and download.

In FIG. 1, the main interface 100 also includes a “Request Forum Access” button 0107. By selecting the Request Forum Access button 0107, a list of forums supported by the COMTOOL communication system are displayed. As alluded to above, the forums can be sorted by category and/or country. Subsequently, the user can select a particular forum to submit an access request for, where the forum is selected from the list launched by the Request Forum Access button 0107.

In the example of FIG. 1, the main interface 100 includes a “Create Forum button” 0108. The Create Forum button 0108 can be configured to provide a user with an interface where they create and name a new forum to be added to the COMTOOL communication system. The user can also add a category (associated with the newly created forum), add forum administrators, accept members, and submit posts to the created forum. Not shown are the buttons for creating a commercial account and requesting access to a commercial account as staff after a user gets a basic account and gets authenticated to the main interface 100.

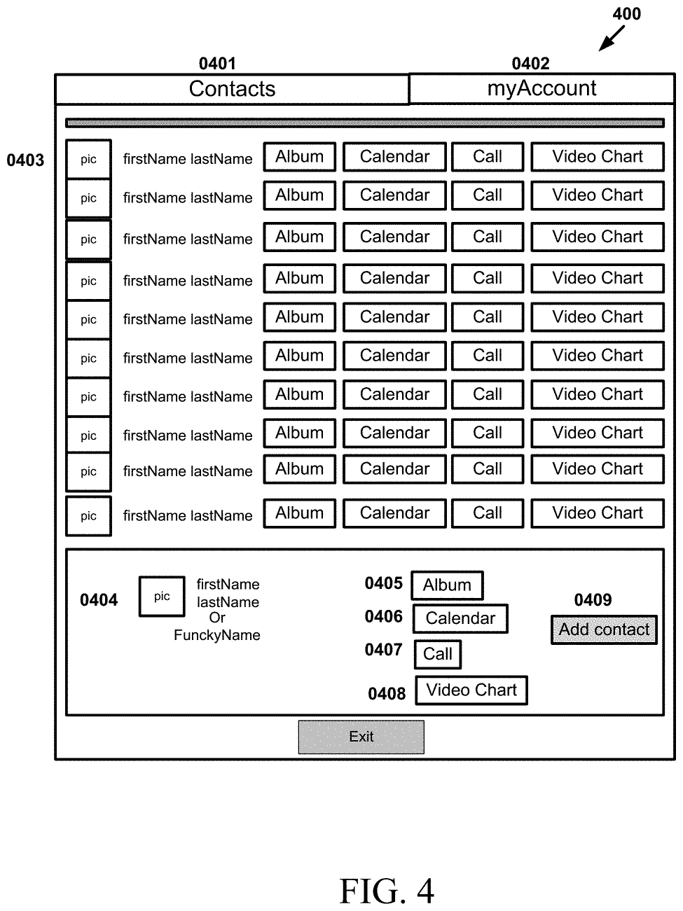

FIG. 1 also shows that the main interface 100 includes a “Contacts” button 0109. In response to the user pressing the Contacts button 0109, a list of all the contacts saved by the user in the COMTOOL communication system is displayed. According to the embodiments, the “Contacts” UI that is shown prominently in FIG. 4 is launched subsequent to the user clicking the Contacts button 0109 from the main interface 100. The COMTOOL communication system can have contacts specifically formatted to includes certain data that may be deemed relevant for identifying and/or interacting with the contact via the system. As an example, a format for a listed contact can include: a thumbnail of the contact's default picture (if they have one); the contact name; a button link to a photo album of the contact (if the user has access); a button link to calendar of the contact (if the user has access); a button link to the Voice Over Internet Protocol (VOIP) phone of the contact (if the user has access); and a button link for a video chart with the contact (if the user has access). By clicking on any of the aforementioned button links that correspond to the contact, the COMTOOL communication system can automatically launch the respective app. For instance, the user can click the VOIP phone button displayed in the contact list, and the COMTOOL communication system can automatically launch the app for dialing the VOIP phone to start the VIOP call between the user and the corresponding contact.

According to the embodiments, the user uploads a picture (visual or graphic file) when their associated account is created on the COMTOOL communication system. The main interface 100 can display that picture in its original file size 0110 or a reduced file size 0111 (e.g., thumbnail). For instance, a cursor hover over the user's picture that is currently displayed by the main interface 100 in the reduced file size 0111 causes a switch, where the picture is then displayed in the larger, expanded original file size 0110.

In addition, the main interface 100 can include various other buttons, shown as an “My Album” button 0112, a “My Calendar” button 0113, a “Phone App” button 0114, a “Video chart and Video Playback” button 0115. The video chart app provides real time video charting which may be saved to file as videos accessible at a later time. As previously described, these button 0112-115 may also be utilized by the user to launch corresponding apps supported by the COMTOOL communication system. As examples, selecting the My Album button 0112 can open an app that displays the user's photo album; selecting the My Calendar button 0113 can launch an app that displays a calendar (e.g., events, important dates) for the user; selecting the “Phone App” button 0114 can launch a phone app for the user; and selecting the Video chart and Video Playback button 0115 can launch an app that enables video chart and video playback. There may also be an “Add channel” button 0116 on the main interface 100 that provides an interface utilized to add content provider channels. In another embodiment, channels can also be added by the user subscribing during video playback. Particularly in the example shown in FIG. 1, all of the discussed buttons 0104-0116 are position in a section of the interface referred to as the header of the main interface 100. Underneath of this header, as seen in FIG. 1, is a “Toggle” button 0117 which can be pushed to collapse the header. Collapsing the header allows for that area of the main interface 100 to be used for other features of the COMTOOL communication system, such as instant messaging. The toggle button 0117 can be pushed again to restore the header back from its collapsed position in a toggling manner, when the buttons 0104-0116 need to be accessible to the user, for example. In some embodiments, scrolling upwards on a computer also collapses the header in a manner similar to using the toggle button 0117.

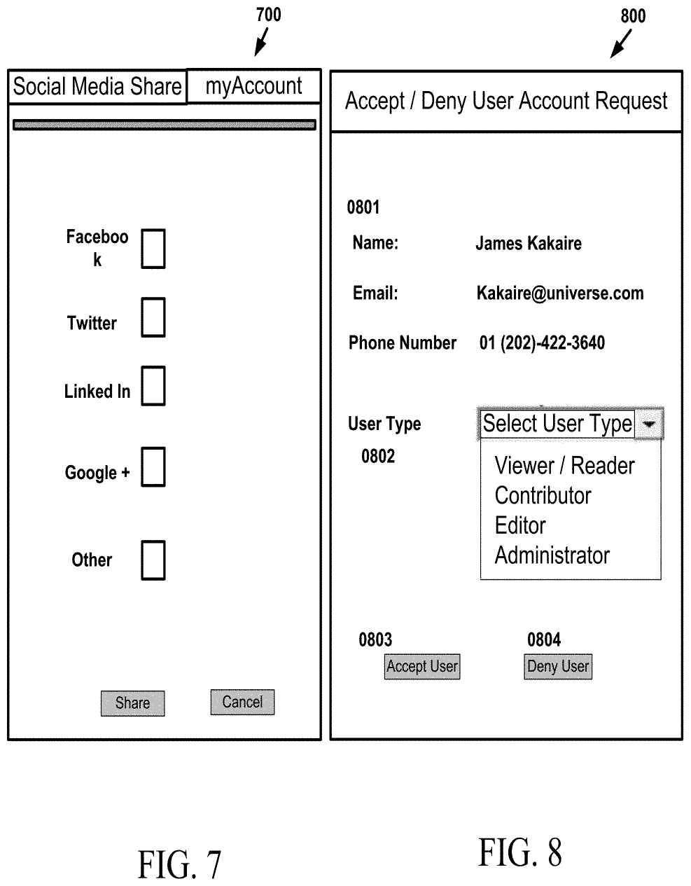

In FIG. 1, below the header of the main interface 100 is another section of the interface, this section includes several other buttons 0120-0126, and 0128-130 and can be employed for displaying instant messages (IMs), for example IMs from the user's contacts. The “Like” button 0120 can be used to interact with the displayed message. The user can select the Like button 0120 to display a thumbs up to the displayed message, meaning that the user, who is reading the IM, views the message favorably. The “Share To contacts” button 0121 allows the user to distribute a message to one or more their contacts. For instance, the user can press the ShareTo Contacts button 0121, which automatically submits a selected message to be distributed by the COMTOOL communication system to all of the contacts who are on the user's contacts distribution list. Also, this section of the main interface 100 can include a “Share to Social Media” button 0122. By clicking the Share to Social Media button 0122, the system can launch a corresponding app displaying a “Social Media Share” UI which is shown prominently in FIG. 7. Accordingly, after selecting the Social Media button 0122 on the main interface 100, the Social Media Share UI is opened which provides a listing of social media platforms such as Facebook™, Twitter™, Linked In™, Google+™, and other platforms where a message can be shared from the COMTOOL communication system. As an example, the user can select a specific IM and the Social Media button 0122 as displayed on the main interface 100, and subsequently select Facebook™ from the list of social media platforms on the Social Media Share UI which causes the system to share the IM with the user's followers on their Facebook™ social media page. Each social media platform, or social media groups, listed on the Social Media Share UI (shown in FIG. 7) can have a corresponding check buttons next to the name of the platform. Thus, a user can click checkboxes to select one or more of the platforms listed in the social media group in which to share a message. Similarly, the user can share messages or posts they have created themselves to the social media groups via the Social Media button 0122.

Furthermore, FIG. 1 depicts a Mini Photo space holder 0123 that is included in the main interface 100. The Mini Photo space holder 0123 can be an area employed to display an image of the author of a currently viewed message. In the event the author has no photo, a default image may be displayed in the Mini Photo space holder 0123. In FIG. 1, directly below the Mini Photo space holder 0123 is a user ID 0124. As alluded to above, a security feature of the COMTOOL communication system involves displaying the user ID 0124 as color coded. The user ID 0124 of a suspected fake account can be shown in a color that is noticeably different from known primary accounts, for instance the user IDs 0124 can displayed in green for a known primary account, while user IDs 0124 of an account having a similar name to an already existing user can be displayed in red. Thus, the COMTOOL communication system can deter imposters from creating “spoofed” accounts having similar names to existing user of the system in an attempt to maliciously deceive the other users. Moreover, the interface may use cascade style sheets or other technologies, so that user IDs 0124 are color coded and images are expanded upon touch or click.

According to the embodiments, the user ID 0124 is a security feature that indicates to a contact that the person writing the viewed message is their original contact. In operation, another person joins the COMTOOL communication system and registers with the same first name and last name that is already in existence within the system, the user ID 0124 being color coded distinguishes this potentially suspicious contact. In an embodiment, the user ID 0124 of the known original users are displayed in a particular color such as green, blue, and the like. Alternatively, the user ID 0124 of the secondary users that register under existing names are displayed in specific color such as red, or yellow, that is different from the color used for the original users. The color in conjunction with the user ID 0124 serves as a visual cue which helps contacts to recognize that the message posted is not from their original contact, who may be a hacker or another potentially malicious source.

The “Album” button 0125, when selected, opens the photo album of the message sender if the user is part of the album user group of that person. Similarly, the “Calendar” button 0126 opens the message sender's calendar. In some cases, these buttons 0125-0126 are grayed out if the user has no access to the contact's album or calendar, respectively. Alternatively, in some embodiments, the buttons 0125-0126 are dynamically not included in the main interface 100 when a user is not part of the group.

As seen in FIG. 1, the main interface 100 further includes a “Request a Contact” button 0128, a “Reply” button 0129, and an add to favorites button 0130. By pressing the Request a Contact button 0128, the user sends a request to the message sender to be added to their contacts in the COMTOOL communication system. In response to clicking the Reply button 0129, an UI providing a text area can be launched from which the user enter text to reply to the message, and subsequently selects a submit button in order to send the reply. The Add to Favorite button 0130 increments a sender's favorite status count, each time it is selected. This favorite count is shown on their sender's profile when displayed to others. The Add to Favorite button 0130 also saves a link to the message content from that user's account, so that the user can view that message later in another interface, for example within a favorites UI (not shown).

FIG. 1 illustrates a post content section 0127, which is followed by a reply section 0131 below it which displays responses to the displayed post. There can be as many replies displayed in this section as posted by other users. This reply section 0131 section also includes the Mini Photo button 0123, the Like 0120 button, the userID 0124, the Album button 0125, the Calendar button 0126, Request Contact button 0128, the Reply button 0129, and the Add to Favorites button 0130 as described in detail above.

Referring now to FIG. 2, a Settings UI 200 of the COMTOOL communication system is illustrated. According to the embodiments, the Settings UI is launched when a user selects the Settings button provided on the main interface (shown in FIG. 1). The settings UI 200 is primarily utilized to configure the independent apps of the COMTOOL communication system and configuring the access privileges to these apps. For example, the user can choose which other users on the system are allowed access to a certain app. The user can make these selections by clicking the checkbox next to the groups desired for allowing access. The default application groups are indicated with a grey filling in the checkbox, but a user can selectively change the settings in the settings UI 200 to be tailored as deemed desirable and/or appropriate.

In the example, the Settings UI 200 lists a group of features or functions of the COMTOOL communication system that have settings to be controlled and/or set via the UI 200. FIG. 2 shows the features as: Postings 0201; Album 0202; calendar view 0203; calendar view and add 0204, calendar view, add and delete 0205, phone voice 0206, video chart 0207; and video playback 0208. In reference to the phone calls and video charts, contacts are added to the user groups before they can call a contact or video chart with them. The checkboxes shown are utilized to add contacts to the respective user groups. Access rights to the calendar app are divided into read, read/write and read/write and edit.

FIG. 2 shows that Settings UI 200 allows a user to set the user types, the user ID, email or phone number of the person they are inviting to have access to the corresponding feature. Once the setting is selected for the specified users to have access, the other party gets a request which shows up under messages. The other user can approve the request by pressing or clicking the accept button, or deny the request by clicking a deny button, or ignore the request (e.g., delete the message).

FIG. 2 also shows “disable feature” buttons 220 corresponding to each of the features in the Settings UI 200. By selecting a disable feature button 220 for the specific feature, the corresponding app which implements this feature is disabled in the COMTOOL communication system. Moreover, FIG. 2 depicts that the Settings UI 200 can include a myAccount tab 0209 for displaying settings related to the user's account. Not shown in FIG. 2 is a setting for default language, which allows users select the language to be used as the default in the system.

FIG. 3 depicts a “Send Message” UI 300 of the COMTOOL communication system. According to the embodiments, the Send Message UI 300 can be displayed in response to a user selecting the Send Message button (shown in FIG. 1). As seen in FIG. 3, the Send Message UI 300 includes the text fields labeled To, CC and BCC where the recipients addresses are placed. Addresses to populate the text fields can be obtained from the contacts button 0301. However, the user can also directly type in the address (internal email) to which the message is going. The formatting menu 0302 of the Send Message UI 300 provides a spell checker, highlighter and other text formatting features such as bold faced, italics etc. In the example, the Send Message UI 300 also includes a message content text area 0303. The message content text area 0303 may also implement an auto spell checker. Furthermore, the Send Message UI 300 includes a “Send” button 0304 and “Cancel”0305 button. Clicking either of the Send button 0304 or Cancel button 0305 causes the system to send the composed message entered by the user (to the indicated recipients), or cancel the message (e.g., message not sent) respectively.

FIG. 4 depicts a “Contacts” UI 400. According to the embodiments, the “Contacts” UI is displayed in response to a user selecting the Contacts button (shown in FIG. 1). As seen in FIG. 4, the Contacts UI 400 displays a miniature version of the contact's default photo alongside the name. The Contacts UI 400 also displays various buttons, for instance a photo album 0405 button that opens the contact's corresponding photo album, and calendar button 0406 that opens the contact's corresponding calendar. In the embodiments, the user is only permitted access to open the contact's album and calendar, if the particular contact has added the user to their album and calendar group. The contact UI 300 further includes the phone call button 0407 and the video chart buttons 0408 for the user to initiate those services if they have access to them with that contact. Not showed is the religious and political group app interface which is displayed along if one is in a user group. The Add contact button 0409 of the Contacts UI 400 adds a contact to a specific application such as album, calendar, phone app or video chart individually.

As an alternative, if the user does not have access to the contact's features, pressing or clicking one of the button links, such as calendar button 0406 provides a button to request access to that service so that they can interact with that particular contact on calendar. Subsequently, the contact can decide to grant or deny access for the requesting user. If access is granted, the user requesting the access is added to a user group that has access to the contact's features, such as the calendar service, for instance.

In some instances, access to one service from a contact does not necessarily apply to another service. That is, access to a contact's Album does not grant access to the calendar or to phone call or to video chart. A user has to be granted access to each of the services individually, in some embodiments even if they have general access with the provider.

The layout depends on screen size. For a small mobile phone screen, a layout displays two lines for each contact.

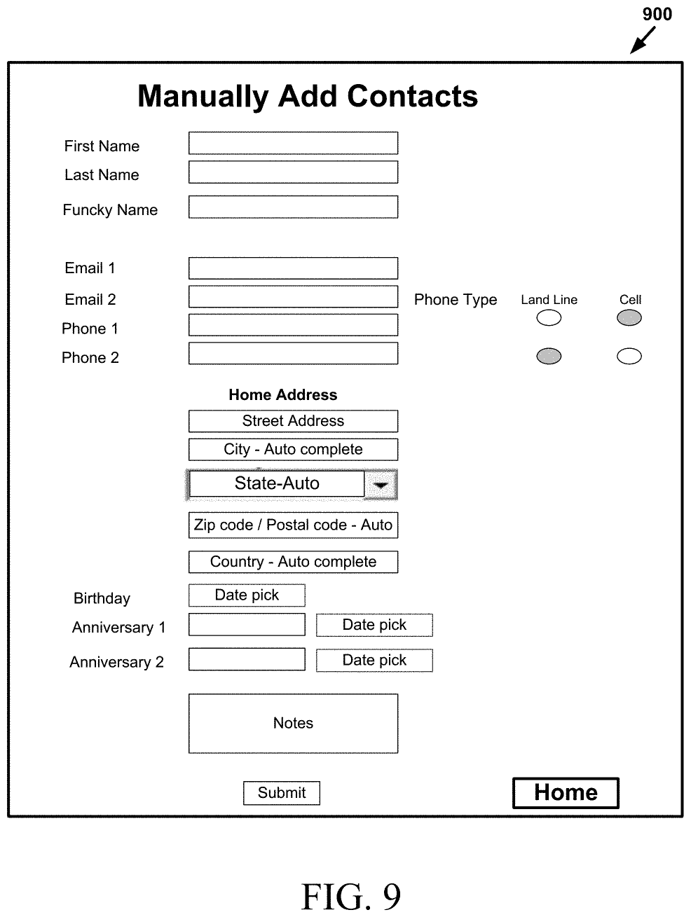

The Add Contact button link 0409 brings up a user interface that enables a user to manually add contacts (shown in FIG. 9). The user adds names of their new contact, phones, emails, address, birthday and anniversaries. The contacts don't need to be users of the COMTOOL communication system in order to be added. However, Comtool users are pulled directly from the database to ease data entry.

The address is linked to a navigation software module. For example, when a user presses contacts, a button for address as is presented as well. Part of the address shows navigation. Upon opening the address, the user gets a button to start navigating. When pressed, it executes navigation to lead the user to that address. Touching a picture or name of the contact also displays address of the contact with a navigation button link and pressing the navigate button link, invokes a navigation module that interact with server based software and positioning nodes on the network connected to, to lead the user to that address.

FIG. shows a “My Forums” UI 500. The My Forums UI 500 displays a listing of all the forums a user has access to. The UI 500 is launched when the user presses or clicks the My Forums button link (shown in FIG. 1). The forums can be organized by category and/or by country.

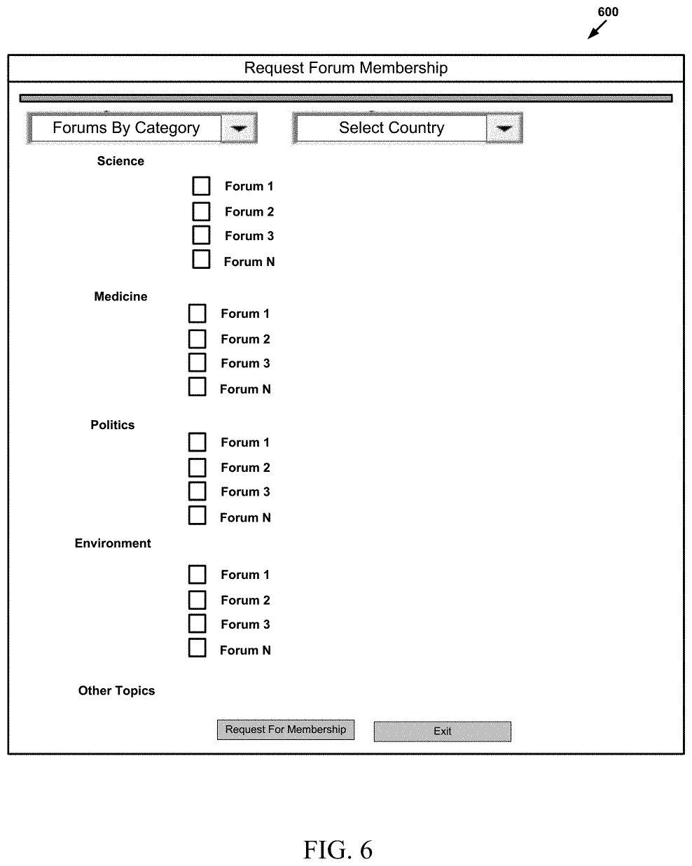

Referring now to FIG. 6, a “Request Forum Membership” UI 600 is depicted.

According to the embodiments, the Request Forum Membership UI 600 is displayed when a user presses or clicks the Request Forum Access from the main interface (shown in FIG. 1). Prior to choosing what forum to ask for, the user is provided with two ways of sorting the forums one being by category and the other by country. The categories are then displayed on a different screen not shown for users to select from.

In FIG. 7, a “Social Media Share” UI 700 is shown. In operation, when a user reads a message and finds it to be sharable or creates their own message that they want to share on social media groups such as Facebook™, Twitter™, Linked In™, Google+™ and others, the user can select the Share Social Media button of the main interface (shown in FIG. 1) which launches the Social Media Share UI 700. To make a choice, the user can select a checkbox corresponding to particular platform for sharing the message content. A confirmation button may be provided before the message is shared. Also, users can get an option of sharing messages to groups in their contacts, and messages are sent to email accounts of the users in the groups when the feature is enabled.

In FIG. 8, an “Accept/Deny User Account Request” UI 800 is shown. The Accept/Deny User Account Request UI 800 can be utilized to add user account requests to a group or one's account. A requestor enters a name, email, phone number and a message into a form not shown requesting to be added to a group or account. Data is saved to a database or file. When the account or group owner or admin logs onto the system, a add account request button not shown displays the UI of FIG. 8. The upper area 0801 shows a requestor's name, email and phone number. The next section 0802 provides a dropdown menu for the admin/owner to select the type of access to be given to the requestor including View or Read only, Contributor, Editor and admin. The Accept user button link 0803 accepts a user and the Deny user button link 0804 denies the user access. A disable user button is utilized to delete or disable a user from a group.

FIG. 9 shows an “Manually Add Contacts” UI 900 of the COMTOOL communication system. The Manually Add Contacts UI 900 maps onto the Contacts entity in the database. The Manually Add Contacts UI 900 is used to add contacts manually though contacts are as well added by pressing or clicking add contact from an incoming message or post. However, contacts added through incoming messages do not contain details such as phone numbers and email. A user obtains and adds them to an existing contact by editing it manually. Manual addition of contacts provides fields for phones, emails, physical address, birthdays and anniversaries. These are only visible to the user and authorized personnel. Additionally, users submit requests to be added to other users' contacts. A request contains name, email and phone number. The host allows or denies the request and decides whether to add the requestor to album, calendar.

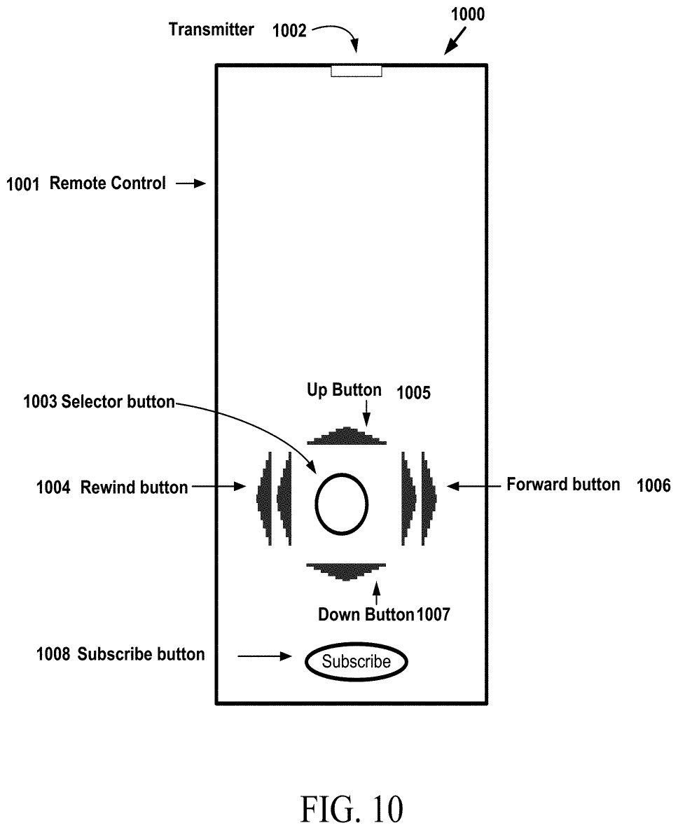

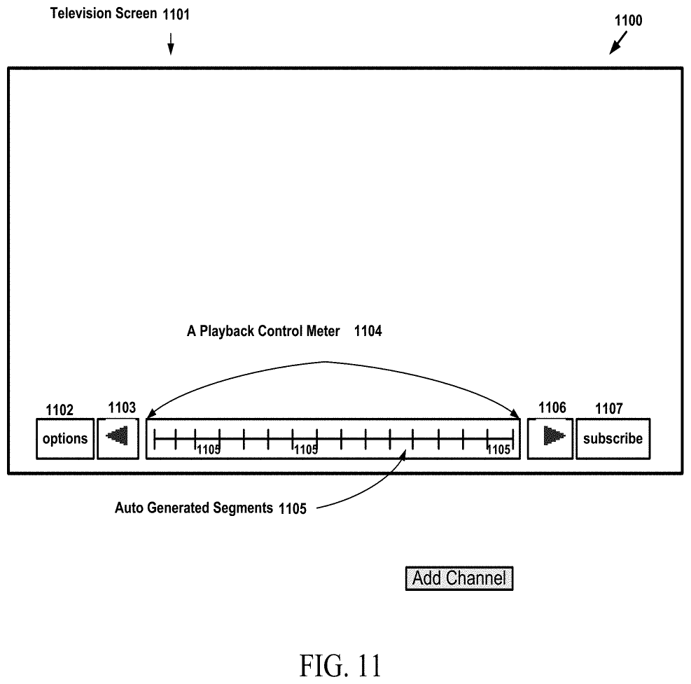

FIG. 10 shows a television remote control 1000 that is implemented by the COMTOOL communication system. The television remote control 1000 can be used to effectuate rewind, forward, and pause functions for videos in playback mode on a television screen. The television remote control 1000 comprises of a remote control hardware 1001, a transmitter lens 1002 for transmitting signal from a pressed button to a television remote control input lens, a selector button 1003 that confirms a previously selected action’ that is, targets a moving cursor(marker) on a playback control meter 1104 and pauses or restarts it. It is pressed to transmit a command as a signal through a remote control transmitter and a television lens. The command is converted to a digital instruction that invokes a software module to pause or restart a video. A rewind button 1004 which when pressed, places the moving cursor on the playback control meter a number of segments backwards as instructed to rewind a video, an up button 1005, a forward button that transmits a forward command as a signal through the remote control transmitter and television lens for conversion into a digital command that moves a playback control meter cursor (marker) on a screen a number of segments forward as instructed 1006 to forward the video and a down button 1007. Holding down the rewind or forward buttons moves the marker (cursor) faster. A subscribe button 1008 transmits commands or instruction to the video playback application to request for a subscription to the current video source channel. The application extracts the cached video id, source channel id and user id from cache memory and transmits it along with a cached user id to subscribe to the channel on the server. If a user has no basic account with the system, the user is prompted to enter name, email and a phone number; and a basic system account is created simultaneously with a subscription to the selected channel. The user then gets the subscription from any device they log onto. FIG. 11 explains how to subscribe to a channel without utilizing the subscribe button on the remote control but double clicking an existing button (designated). The designated button double pressed or clicked to subscribe may be the selector button 1003 or other. Users are automatically notified by email and text messaging whenever new content is uploaded to the channels subscribed to. The subscribe button 1107 on the television screen displays during video pause mode or at end of video playback. Subscribing to a video channel source in pause mode or at end of playback mode is accomplished by utilizing the designated button on a remote control that when double pressed, transmits instructions to the video playback application to request for a subscription in relation to the displayed subscribe button 1107 on the television screen. The reader that reads instructions from the remote control executes a delay when reading the designated button input to allow for a double press because a single press is utilized to pause or restart video playback. Words similar to “Double Press Selector To Subscribe” are displayed on screen when the subscribe button is displayed. The subscription instruction is transmitted to the processor and saved to a database in server memory.

It should be appreciated that the television remote control 1000 can include other button links that are not shown in FIG. 10. For example, when pressed, a button on the television remote control 1000 transmits a radio, WI-FI or Infrared based signal corresponding to the pressed button instruction and this is received through a television signal lens as an instruction. It is converted to a digital command that invokes a software module to perform the requested action and display it on the television screen.

FIG. 11 illustrates an example of a “Television” UI 1100 of the COMTOOL communication system employed for rewinding, forwarding and pausing a video in playback mode on a television screen utilizing the television remote control UI shown in FIG. 10. The television screen is on a television set which is wirelessly coupled to a remote control that submits instructions to the television with an operating system in memory. The television screen comprises of a display screen 1101, an options dropdown menu 1102 that expands on click to display available options such as add to favorites, subscribe to content provider group, like, dislike etc. a rewind button 1103, a playback control meter 1104, divided up into segments 1105 whose number (quantity) depends on video length. The algorithm that displays the video playback control meter and execute commands, takes in as parameters a video id, a video length and related data to display. It converts the video length to seconds. The algorithm then assigns the number of seconds in video length (VL) of the uploaded video to number of segments (NS) 1105, 1479. A subscribed user creates a favorites DVR that is located on a server and accessible by authentication. The television memory is coupled to at least one processor that transmits instructions to a server via a wired or wireless network and retrieves data from the server which data is displayed on the television.

The NS in the playback meter are equivalent to the number of seconds in the video length. That is, a 4 hour video will have 4 hours×60 minutes×60 seconds or 144,000 seconds. Each second is assigned one segment in the playback meter. A playing video advances to one segment every second that elapses. The segments are then drawn in a single row of an html table as table cells. Each table cell=one segment=second. A forward button which is different from the one on the remote control, is represented by 1106. When a video loads to play, its parameters including video id and channel id are cached along with the authenticated user id and utilized to subscribe to a channel. The subscribe button 1107 displays during a video pause and at end of video playback. A hardware key on the remote control 1008 is designated to transmit a command that is interpreted as a subscribe command or instruction in the video playback application. Similarly, the selector button on the remote control confirms a pause of a video in playback mode and generates segments that represents motion of a marker (cursor) and portion of the video played. It is designated to transmit a subscribe command when a user double clicks. On double click of the selector button of the remote control, the video application invokes the subscribe button 1107 which takes in video id, source channel id and the authenticated user id as parameters and adds the user to subscribers on the channel. When a video is paused, a single click on the selector button of the remote control restarts the video and a double click selects the subscribe option button 1107. User parameters are cached along with video channel parameters during playback wherein double pressing a selector button on a remote control selects the subscribe button and transmits a subscription request to the video source sending channel id and user id to subscribe. The subscription command is transmitted to the processor and saved to a database in server memory.

When uploading videos, users are provided with a text field to enter a message such as a website Uniform Resource Locator (URL) to display during video playback. In another text field, a user enters time at which they want the message to display based on how long (video length) a video plays. If a video is 9 minutes long, the user may specify that at minute 7:23, display the URL in the center, left top or right top of the video play back screen. The video application reads elapsed time and extracts the message parameter from the session cache and displays it on screen at a specified time as a uniform resource locator (URL) or other message.

A marker or cursor is placed in the video playback meter segment to indicate current location of view. A pause stops the marker from advancing, a forward moves the marker forward to the next division and a rewind moves the marker backwards. A drag and drop manually moves the marker multiple segments in each direction as instructed by a user. An action listener determines which playback meter segment the marker is rested in and calculates the number of minutes or hours viewed. The meter is displayed when paused.

A portioned viewed so for is displayed up to where the marker rests during the pause. When the marker is at rest, a play button is displayed instead of the marker for selection utilizing the selection button of the television remote control 1003. When a video is playing, the playback control meter is made invisible by giving all the html table elements a Cascade Style Sheet (CSS) opacity of zero (0) which makes them transparent. Other technologies similar to CSS may be utilized to accomplish this.

At a time of a video pause, forward or rewind, the playback control meter is floated on top of the video by assigning it a higher Cascade Style z-index than the video. All elements of the playback control meter represented by a single row of an html table are given Cascade Style opacity of zero (0) to make them transparent and invisible except the central meter part that shows the portion of a video played back so far. This is assigned a greater that zero (0) CSS opacity to make it visible in any desired color.

A mouse click is utilized on a computer and touch screen is used on mobile phones and tablets to pause, forward or rewind videos in this system.

The videos are categorized in the database and indexed based on content type and content providers for easy selection and finding related content. Categories vary from technology, science, politics, travel to whatever.

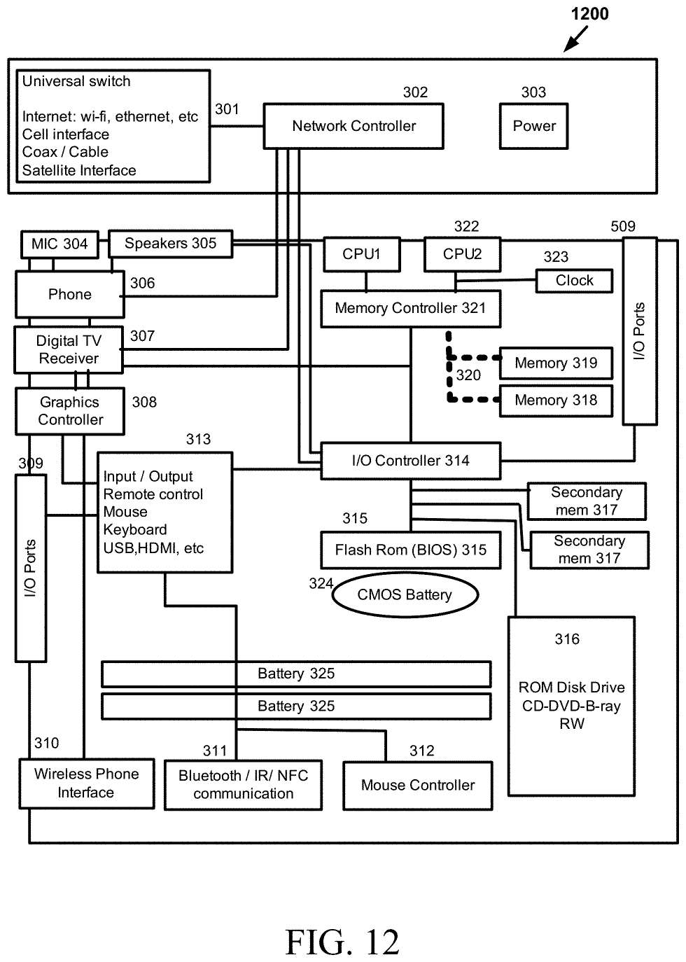

FIG. 12 is an example configuration of a universal circuit board 1200 that executes instructions issued to a processor of a television, computer, tablet or mobile phone that runs the COMTOOL communication system, disclosed herein. Software programs can only run when installed on hardware devices including servers which distributes data to individual devices. FIG. 12 depicts the universal system board 1200 that covers computers, televisions, tablets and mobile phones. It illustrates how instructions transmitted by algorithms to the processor via user interfaces interact with database schemas or files in memory to process, save or retrieve data. On a mobile phone or computer device, a user submits instructions also referred to as commands through an icon or button to launch an application that displays a graphical user interface from which the user executes additional instructions. The Input Output (I/O) ports 509 on the figure are connected to a keyboard, mouse, voice input and display of a device. The device is divided into user devices which include mobile phones, tablets, computers and televisions, and cloud devices such as servers. The I/O receives user instructions and invokes algorithms to submit instructions to the central processing unit (CPU) 322 or processor via the I/O Controller 314 and Memory Controller 321. The processor invokes algorithms in a particular program or application tasked for an event. Some of the algorithms executes from user devices while others executes from servers. The algorithms results into displaying of more user interfaces, data collection and submission to the server. The processors on the servers' works with the algorithms to process the data and save it to database schemas or files stored in server memory 317. Similarly, data is retrieved from database schemas on servers, processed and displayed to the user mobile device, computer or television accordingly. The user device which also carries at least one processor, submits commands to the processor to execute desired I/O tasks.

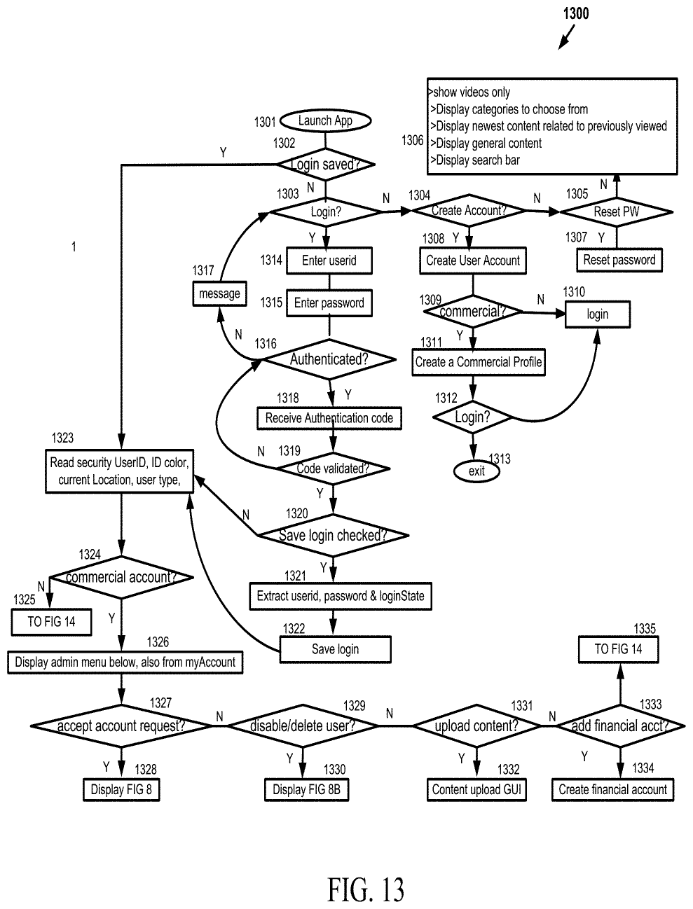

FIG. 13 is method 1300 for creating accounts, authenticating users and managing the user accounts. The method 1300 can start by the user launching an application 1301. When the user's login credentials are not saved 1302, the user gets a basic menu (not shown) giving options to choose from login 1303, create account 1304, reset password 1305 or display videos 1306.

If the user chooses to create an account from the menu option 1304, they create an account 1308. After creating the basic account, the user is prompted to create a commercial account 1309 or login 1310. If the user creates a commercial account 1311, the user logs in 1312 and exists 1313.

If at the menu the user chooses to login 1303, the user enters user id (phone number or email) 1314 and password 1315. The algorithm identifies users by user type and transmits instructions to the server processor to test for account completion steps in the database and authenticates a user to display a menu based on user type which includes basic, commercial admin or staff 1316, If not authenticated the user gets a message 1317 to try again or other. An authenticated user receives an authentication code on their mobile device or email 1318 and the code is validated 1319. The user is offered an option to save their login 1320. The system extracts user the user id and password from the session 1321 and saves the login 1322.

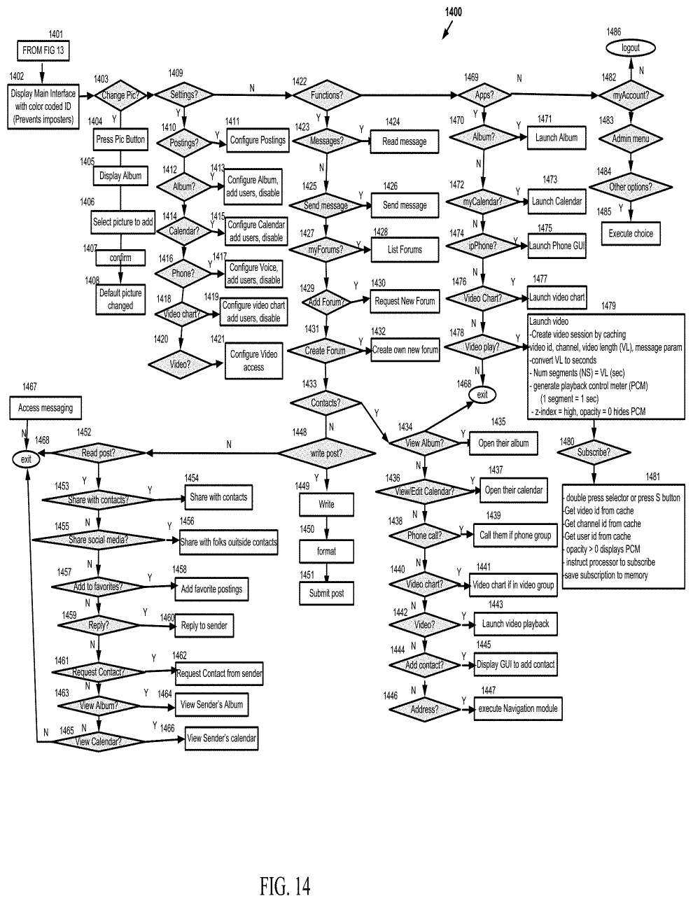

If login credentials were previously saved, a user session at step 1302 would read the user's security userId which comes with a color code for preventing imposters, current location and user type 1323. The system then test for type of user 1324. If user is a basic user 1325, they are forwarded to FIG. 14 else if the user has a commercial account, the system displays a menu interface with the options of accept account request 1327, disable or delete an existing user account 1329, upload content 1331 and add a financial account 1333 all of which comes with interfaces as shown by 1328, 1330, 1332 and 1334. Financial setup and edits include but not limited to change of payment methods such as direct deposit to a bank account, electronic check, pre-paid debit cards and location pickup. Where applicable, users also set and change tax information and personal data such as address, email and phone number and the changes are saved to database in memory. The option to accept an account request 1327 includes adding user accounts with different access rights such as viewer/reader (read only), contributor, editor and administrator that performs all functions on the account.

A create account mechanism for creating a user account from a mobile phone, tablet, computer or television set consisting of an account creation, authentication and management algorithm, an initial interface with a designated window for displaying ads from the server, a create account button, a text field where to enter email or phone and another for password to login.

The create account button link opens a new interface with text fields to enter name, email and phone number to create a basic user account. The mechanism also comprises of a button link on the main interface for creating a commercial account after a user is authenticated and another button link for requesting an account as staff to a commercial account. This sets up user types of a basic user, a commercial admin and staff. A submit button transmits instructions to a processor to create a user account and this causes the processor to invoke the algorithm that creates accounts and saves in a database in server memory. A commercial user creates an admin account for managing staff and staff submits a create request to the admin account via a form in the application sending name, email and phone number to create a partial account.

A separate form is utilized to request a staff account to a commercial account when a user does not have a basic account. The user enters name, email and phone number and a partial registration account is created for the user. The commercial admin views the request and completes the account by assigning it a user title which comes with access rights. The confirmation is submitted to the server to update the partial account. The new staff and the admin are notified by email and text messaging that the account is complete. The new staff then acts as a content provider and gets other assignments as the admin may determine.

FIG. 14 is a method 1400 for displaying and enabling the various interfaces implemented by the COMTOOL communication system, as disclosed herein. The method executes several interfaces and independent apps. As shown in FIG. 13, the method 1300 authenticates a user and continues through FIG. 14 to display the main interface 1402. The command 1403 provides a button link 1404 to press and display a picture album 1405 to select a picture to add 1406. A confirm button 1407 is provided to change the picture 1408.

The settings option 1409 provides an interface with options and button links to configure the various applications in the system. Choice 1410 configures postings 1411 and determines how postings display on a device. The command 1412 provides options to configure an album and manage users 1413 of the album. This includes adding new viewers and deleting other users. The calendar option 1414 configures a calendar that comes with the system and provides an interface from which a calendar owner adds and deletes users 1415. Users added are given permission levels that include read, write, edit and delete. A voice over IP phone app 1416 provides users with an interface 1417 from which a user add and remove other users. The video chart option 1418 utilizes the interface 1419 to add users of the application from contacts and remove unwanted ones. Similarly, the video configuration interface 1420 provides a user with options to add users from contacts that can view posted videos.

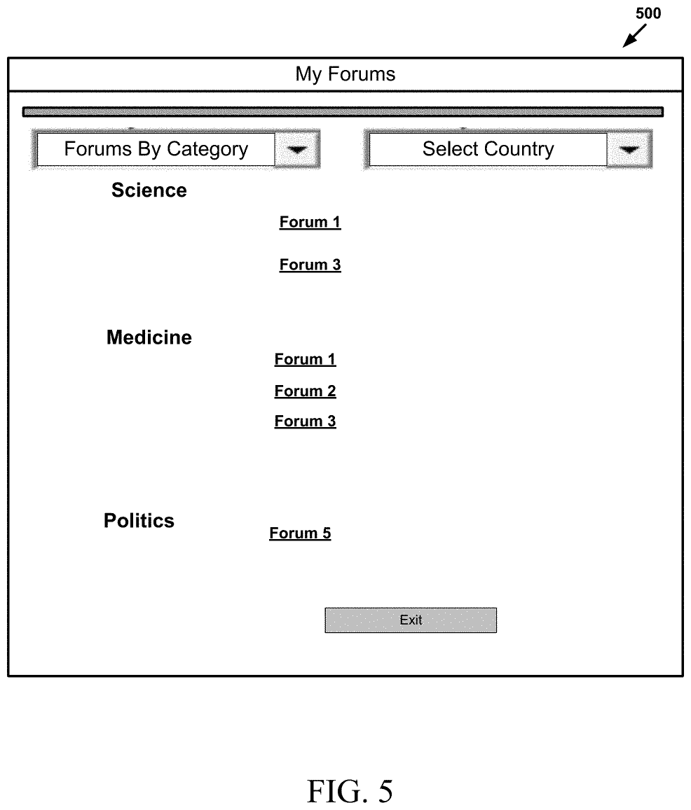

The functions option 1422 comprises of several button links on the interface of FIG. 1 that issues commands and invoke modules to accomplish the listed functions. The messages command 1423 invokes the read messages module 1424, the send message command 1425 sends message 1426 and the myForums command 1427 invokes a module that lists all forum a user has access to 1428 as seen in FIG. 5. The add forum command 1429 requests for membership to a forum 1430 utilizing the interface of FIG. 6 which lists the forums by category and can be sorted by country. The create forum command 1431 provides an interface 1432 from which a user creates their own forum and manage it. Other users request for membership and the forum creator adds the requests.

If a user hits a Contacts command 1433, it invokes a module that displays the interface of FIG. 4. This lists all the contacts as records with functions that can be taken against the contacts and these includes viewing the contacts album, calendar, accessing voice over IP phone call app, video chart and viewing video. The view album command 1434 opens the album 1435, view or edit calendar 1436 opens the calendar 1437, phone call 1438 invokes a voice over IP phone interface 1439 for the user to call the contact, video chart 1440 displays an interface 1441 from which the user video calls the contact, the video command 1442 invokes a video playback application 1443 where videos are only viewed by user groups. The add contact command 1444 displays a GUI 1445 which is the user interface of FIG. 9 to manually add contacts. When a contact's address is in the system, the address command 1446 invokes a navigation module 1447 that leads the user to the contact's address.

If the user decides to write a post utilizing the main interface 1448, the interface 1449 provides a text field and a submit post button link to write, format 1450 and submit the post 145 When the user decides to read a post 1452, a share with contacts command 1453 is utilized to share with contacts 1454. The share with social media command 1455 generates a link 1456. A module invokes the interface of FIG. 7 for the user to choose what social media outlets to share with. The share button submits the post as a link. Social media readers open the link from the user's home page and contents are not saved to the social media outlet. The add to favorites command 1457 adds the post to favorites posts 1458 that can be read again. The reply command 1459 replies to the post 1460 and the request contact button link 1461 submits a request contact from sender of the post 1462. The view album command 1463 opens the sender's album 1464 only when the viewer has permission to view the album. The view calendar command 1465 opens the sender's calendar with permission 1466 and access level in place. The messaging module 1467 provides instant messaging within the system.

The various apps in this system 1469 are accessed through button links on the graphical interface of FIG. 1. The album 1470 launches the album app 1471, the myCalendar 1472 launches the calendar 1473, the IP phone 1474 launches a phone GUI 1475 utilized to make phone calls. The video chart command 1476 launches the video chart interface 1477.

The video playback command 1478 launches a video playback application 1479 which creates a session for the uploaded video and cache the video id, video source channel id, user id, device id, video length (VL) and zero or more message parameters. A message parameter is utilized to store a variable such as a URL a video owner wants to display on a television screen when the video is being played. The message can be displayed anywhere on the screen. It does not require the content provider to have special software or skills for placing a URL on a television screen when the system is installed in a television set. The video length (VL) is converted into seconds. The video playback control meter of FIG. 11 is divided into small segments. These segments are assigned a value of one second. Utilizing video length of any given video, the number of segments in the video playback control meter is equal to the number of seconds in video length of the uploaded video. The television screen in the interface of FIG. 11 shows a video playback control meter (VPCM) that is auto generated from a single row of html table cells. Each cell=one segment=one second. The VPCM floats on a playing video when assigned a higher cascade style sheet (CSS) z-index and it is made transparent by giving it a CSS opacity of zero (0) which makes it invisible during playback. The subscribe button 1107 displayed on the interface of FIG. 11 accessed by double clicking a designated button on the television remote control such as the selector button 1003 or pressing the physical subscribe button 1008 invokes the subscribe command 1480 to get or extract parameters in the video session or cache 1481 including the video id, id of the video source channel, user id of the authenticated user and assign a high CSS opacity greater than zero (0) to make the video playback control meter and the subscribe button visible. The algorithm submits the instructions to the device processor and server processor to save the subscription to the server memory. This can be in the database, files or elsewhere in the memory.

The myAccount command provides menu options that includes an admin menu for managing a commercial account 1483.

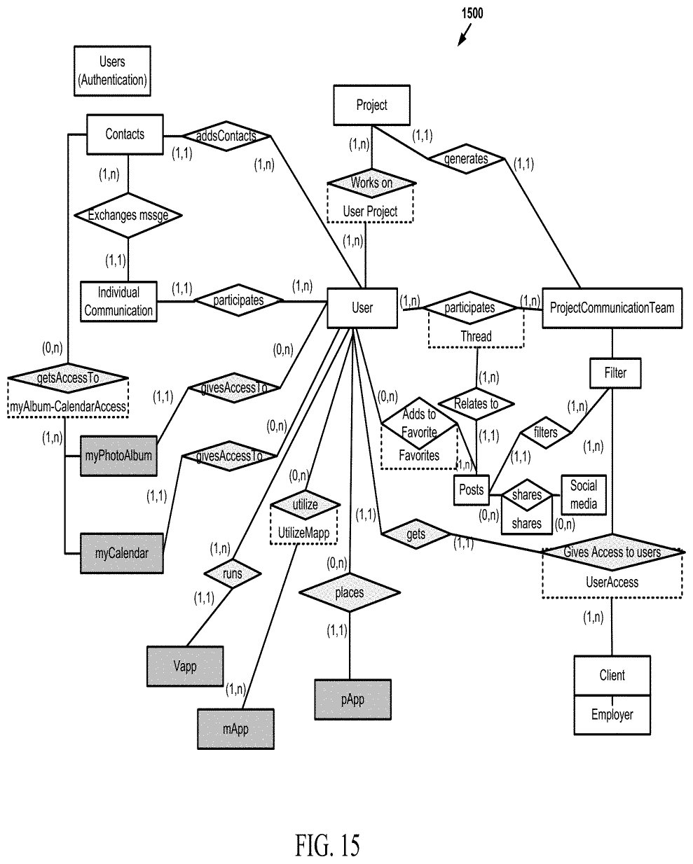

Referring now to FIG. 15 an ERModel 1500 is shown, which represents the database system of the COMTOOL communication system. The entity users stores details of all individuals that use the COMTOOL in general. There are two types of projects. One is initiated from the COMTOOL directly and the other type is initiated from a different application such as the Scheduler, Move Tool or the Worker Acquisition, Customer Acquisition and Payment System. Any applications that interact with the COMTOOL stores their user details in the Users entity prior to interaction.

For job related apps such as the Worker Acquisition, Customer Acquisition and Wage Payment System, location and current Location attributes of the user entity in relation to a job site allows the algorithm to assign the user to the right communication group based on radius of where they are and match them with the right groups. However, if the user is at their home address, the home address is used in the algorithm to determine the best suited communication group.

The Entity Projects represents a task such as a job or organization for which two or more people working on a project communicate via the Comtool messaging system to accomplish their goals. The Project and User entities generates another entity UserProject to which a client writes names of the scheduled people working on her project. Each record in this entity is established with a project ID and a User ID plus any other activity data that may be saved in the entity.

To access the project communication, the application software reads the record from this entity UserProject and compares the project ID, User ID that corresponds to that project, date and time range of the project to ensure the user belongs to that group communication group since other users may work on the same project at different times. The UserProject entity is now utilized instead of the main Users entity. This is optimization. The main Users entity is accessed only when names or other user details are needed.

One of the attributes in the UserProject entity is “dateProjectSignedOff (completed)”. This attribute is utilized to wipe the communications at the end of the project or when it is decided to clean up the database.

Since many different projects can be started at different times, the entity Projects generates many different project communication teams. The project teams are stored by reference (project team id) in the entity named ProjectCommunicationTeam.

Though there could be many members of an organization in the Users entity, only people inserted into the UserProject entity by reference and their respective communication project inserted into the ProjectCommunicationTeam entity by reference can communicate on behalf of that project. In such a case, the guest application inserts members by means of a button link that calls a module to select all intended users from the entity where they are.

One such example is that of scheduled employees in the Scheduler application which functions in conjunction with the Move Tool to facility communication in a work environment where users are scattered with their mobile devices.

The entity Thread is a result of the many to many relationships between the Users and ProjectCommunicationTeam entities. It stores communication threads. It has a location attribute which provides the relative location of the user. This location determines the users that can see ride requests or offers within a specified radius. It also has a current location attribute for job related and displays and selection of which forum to get place the user to if they need a ride or want to offer rides. All threads to the posts are stored here and ordered by date and time when displaying.

Favorites is the entity where users saves posts that they like by selecting the button link named Add to Favorite on the main interface. Users add posts to favorites and the id of the author is saved as well to identify the author when issuing author status. Videos in playback mode, pause mode or at end of playback are added to favorites in a similar manner. Each time a post or video is added to favorites, it generates points for the author or video content provider. This credit (points) is incremented each time a posting is added to favorite. The points accumulate to elevate the author or video content provider status.

Posts is the entity that stores the actual messages posted by users. It contains an attribute named favoritePostCount which keeps track of the posts that are saved by readers as good or their favorite posts and added to the favorites.

The entity UserAcccess stores user id of the person that gives a user access to a forum. The entity also stores id of the user that was given access and the projectCommunicationTeam to which they were given access.

Below that is the entity named Client-Employer. This one stores client or employer info.

The entity Contacts stores a user's contacts. These include internal Comtool users and contacts from outside typed in or saved from email accounts. A user can manually add in any contacts they want including their phone numbers and addresses so that they access them from anywhere and from any device.

When a user opens the contacts entity via a button link, it displays all the contacts in an ordered manner. They can select one contact and choose to view their photo album, view or edit their calendar if they have edit rights, call the contact over IP if they are part of the phone group or initiate video chart if they are part of that contact's video chart user group.

The Individual Communication entity stores messages between two users one on one only. The myAlbum entity stores a user's personal photographs which are accessed by authentication and the myAlbumAccess entity stores authentication related information to myAlbum.

Similarly, myCalendar stores calendar related info which is also accessed by authentication and the myCalendarAccess entity stores authentication info related to myCalendar. The vApp entity stores information related to video chart access while the pApp stores information related to Phone authentication groups.

The mApp entity stores information related to a separate app not described in this application.

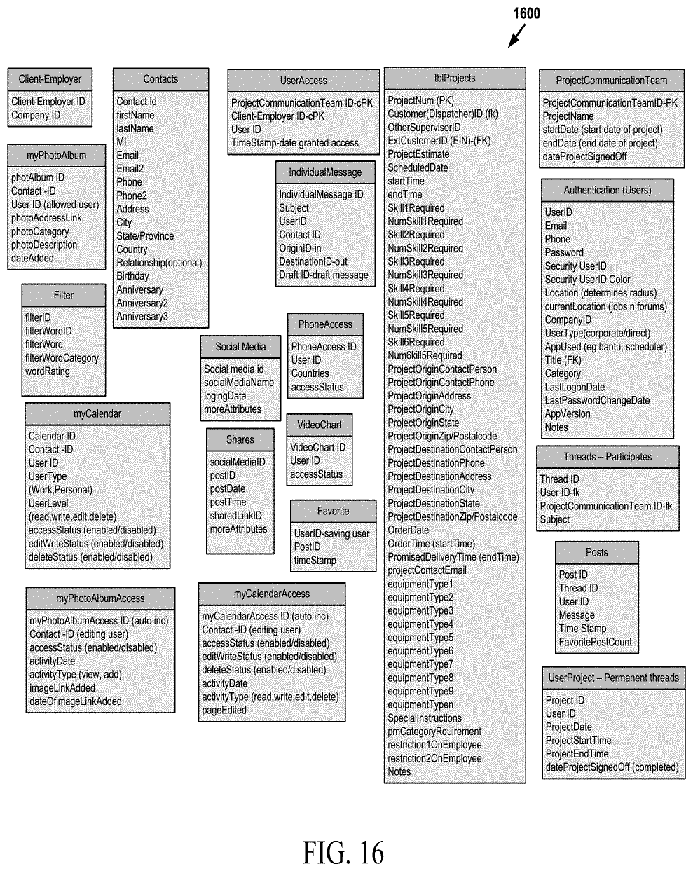

FIG. 16 illustrates a database schema 1600, which represents the Entity Relationship Model of FIG. 15 in an expanded form that showing entities and their attributes.

The Users entity has the attributes Security UserID and Security UserID Color are primarily used for securing user posts against imposters that creates accounts to mimic existing accounts. When a user creates an account with someone else's identity and becomes a contact with that person, any posts they put out are not distinguished from the original user's posts. This UserID and color code solves that problem by providing one color for all initial users with a given name and a different color for secondary users that have names similar to some individuals. This is showed in FIG. 1 where the user id and user id color code are read from the database and displayed in color.

Other attributes are in the entity are used according to the primary keys and foreign keys as seen the related entities.

The Projects entity provides attributes such as project site location, date and time of the project and so on. This information is utilized to build an entity UserProject used to communicate with related entities such as Threads and ProjectCommunicationTeam. In any of the above entities, projectDate, projectStartTime and projectEndTime attributes are used when selecting users for a project communication team from scheduled users. These three attributes are in addition to user id and project id.

In the entity UserProject or any other entity used to track project progress and end time, there is an attribute named dateProjectSignedOff or completed. This attribute is utilized in deleting of the communication threads and posts after completion of the project.

The Thread entity which stores threads to the posts is a resultant entity from the Users and ProjectCommunicationTeam entities which provides userid and projectCommunicationTeam id as foreign keys but they are not used as composite keys because a user may post more than one message which repeats both keys. A thread id is introduced for that reason to act as a primary key. The thread entity also stores the subject of the posts. All are referenced by foreign keys in the other entities. Posts are ordered by date and time in reference to their parent post.

The Posts entity stores an attribute named FavoritePostCount which keeps track of the number of times a post is saved as another user's favorite. The result is displayed to the message poster's profile as number of favorite postings.

The entity Favorites stores links to a user id that adds a post to the favorite entity and the post id so that the post can be retrieved for the user anytime they want to access it.

The Contacts entity stores user's contacts whether internal or external. A user manually types in contacts of any kind with their phone, email, address, birthday and anniversaries. The Comtool application software reminds the user when their contacts anniversaries or birthdays are approaching. Additionally, a user gets access to their contacts data from anywhere either through the mobile app or by logging into the Comtool website.

The myCalendar and myCalendarAccess entities keeps track of the calendar authorizations and access. Various user levels are given out to users and these includes view only, view and add, edit and delete. They keep track of changes and user id's that make the changes. They have access attributes that stores status for each access type. The user can disable and re-enable the service at any time.

The entities myPhotoAlbum and myPhotoAlbumAccess keeps track of album access which is only by authentication. Even if a user is a contact, they don't automatically get access to the photo album or calendar. The owner can disable or enable this service at any time and the status is stored in one of these entities decided after normalizing the DBMS.

The photoCategory attribute allows the user to categorize the photos such that certain users gets access to specific photos but not all users. User groups are created to accomplish this.

The Phone and Video Chart entities also have accessStatus attributes that stores usage status of those services. When disabled, the button links to request for the services do not show on other people's screens and they can't get in touch with the user via those services.

The entity Filter contains several attributes including filterID for identifying the filter, filter word for the words to which contents of the posting are compared when looking for fake news, filter word category for classifying the words and word rating for giving them a numerical value which determines their effect on a related event. Users categorize content when posting.

The entity Social Media contains attributes which includes social media id for identifying the social medial involved, social media name, login data for allowing the user posting a link to access the social media account, and more attributes.

The entity Shares contains a social media id, group id for use with a group, contact id for use with an individual, post date and post time for automating the links to publish at the time the user wants them to and more attributes

The rest of the entities and attributes work according to their primary keys and foreign keys with the entities they relate to as shown in the database schema.

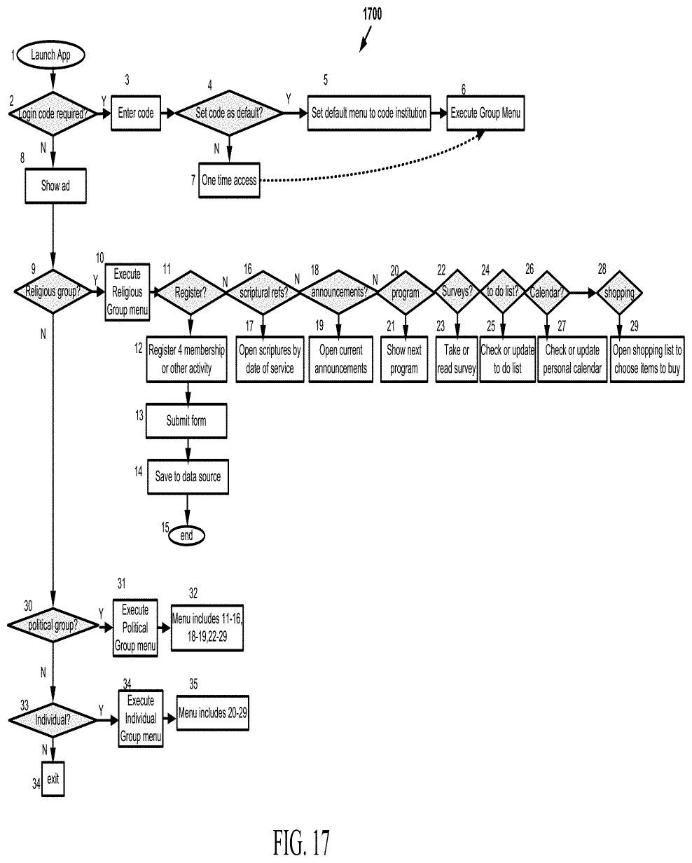

FIG. 17 depicts a representation of a Religious and political App 1700 characterized by a tabular display with a screen cell utilized for displaying textual, video and audio ads. Specific modules are used to control input and output in the App.

The Religious App displays registration forms, scriptural references, announcements, institution programs, surveys and personal to do lists, calendar and shopping list among other tasks. The Political App on the other hand displays registration forms, announcements, surveys, postings, response to postings, archives and to do lists, calendar and shopping list among other tasks in the Apps. These tasks results into entities that are to be placed in the ER-Model 1500 and corresponding database schema in the final application.

The system is made up of a user device with at least one processor coupled to a clock, memory controller and random access memory that processes incoming and outgoing data and issues instructions to communicate through a wired or wireless network. It transmits the said instructions to a server to execute; and a plurality of interfaces invoked by algorithms that interact with a database and files system utilized for data storage. The system further comprise of at least one server with a processor coupled to server memory that stores at least one database and computer executable instructions that when executed by the processor causes the server to launch modules in the application with embedded queries to retrieve data from the database or files, process and save incoming data. The system simplifies the process of electronic communication by integrating functions of various communication applications making them accessible from one interface over wired and wireless networks.

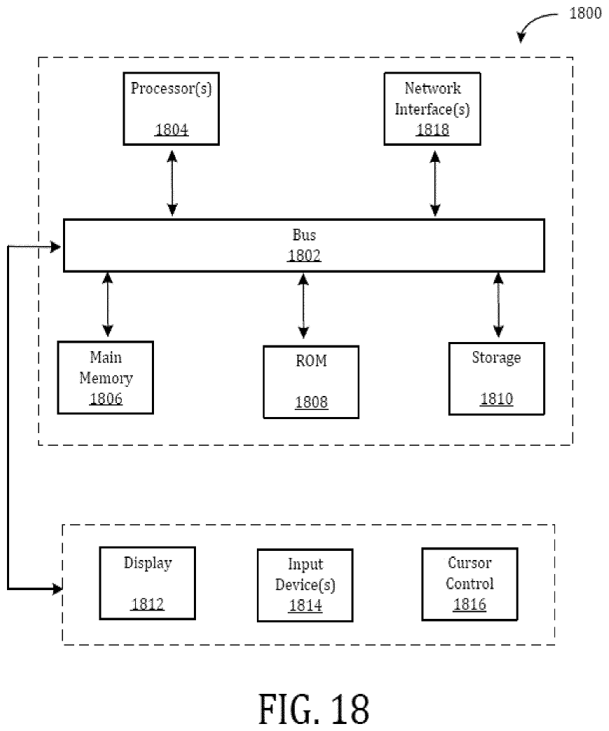

FIG. 18 depicts a block diagram of an example computer system 1800 in which the disclosed aspects of the COMTOOL communication system may be implemented. Furthermore, it should be appreciated that although the various instructions are illustrated as being co-located within a single processing unit, there may be some implementations in which processor(s) includes multiple processing units, allowing one or more instructions may be executed remotely from the other instructions.

The computer system 1800 includes a bus 1802 or other communication mechanism for communicating information, one or more hardware processors 1804 coupled with bus 1812 for processing information. Hardware processor(s) 1804 may be, for example, one or more general purpose microprocessors.

The computer system 1800 also includes a main memory 1806, such as a random access memory (RAM), cache and/or other dynamic storage devices, coupled to bus 1802 for storing information and instructions to be executed by processor 1804. Main memory 1806 also may be used for storing temporary variables or other intermediate information during execution of instructions to be executed by processor 1804. Such instructions, when stored in storage media accessible to processor 1804, render computer system 1800 into a special-purpose machine that is customized to perform the operations specified in the instructions.

The computer system 1800 further includes a read only memory (ROM) 1808 or other static storage device coupled to bus 1802 for storing static information and instructions for processor 1804. A storage device 1810, such as a magnetic disk, optical disk, or USB thumb drive (Flash drive), etc., is provided and coupled to bus 1802 for storing information and instructions.

The computer system 1800 may be coupled via bus 1802 to a display 1812, such as a liquid crystal display (LCD) (or touch screen), for displaying information to a computer user. An input device 1814, including alphanumeric and other keys, is coupled to bus 1802 for communicating information and command selections to processor 1804. Another type of user input device is cursor control 1816, such as a mouse, a trackball, or cursor direction keys for communicating direction information and command selections to processor 1804 and for controlling cursor movement on display 1812. In some embodiments, the same direction information and command selections as cursor control may be implemented via receiving touches on a touch screen without a cursor.

The computing system 1800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Python, Ruby on Rails or NodeJS. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1800 may implement the techniques described herein using customized hard-wired logic, one or more ASICs or FPGAs, firmware and/or program logic which in combination with the computer system causes or programs computer system 1800 to be a special-purpose machine. According to one embodiment, the techniques herein are performed by computer system 1800 in response to processor(s) 1804 executing one or more sequences of one or more instructions contained in main memory 1806. Such instructions may be read into main memory 1806 from another storage medium, such as storage device 1810. Execution of the sequences of instructions contained in main memory 1806 causes processor(s) 1804 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1810. Volatile media includes dynamic memory, such as main memory 1806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1802. Transmission media can also take the form of acoustic or light waves, such as those generated during radio-wave and infra-red data communications.

The computer system 1800 also includes a communication interface 1818 coupled to bus 1802. Network interface 1818 provides a two-way data communication coupling to one or more network links that are connected to one or more local networks. For example, communication interface 1818 may be an integrated services digital network (ISDN) card, cable modem, satellite modem, or a modem to provide a data communication connection to a corresponding type of telephone line. As another example, network interface 1818 may be a local area network (LAN) card to provide a data communication connection to a compatible LAN (or WAN component to communicate with a WAN). Wireless links may also be implemented. In any such implementation, network interface 1818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local networks and Internet both use electrical, electromagnetic or optical signals that carry digital data streams. The signals through the various networks and the signals on network link and through communication interface 518, which carry the digital data to and from computer system 710, are example forms of transmission media.

The computer system 1800 can send messages and receive data, including program code, through the network(s), network link and communication interface 1818. In the Internet example, a server might transmit a requested code for an application program through the Internet, the ISP, the local network and the communication interface 1818.

The received code may be executed by processor 1804 as it is received, and/or stored in storage device 1810, or other non-volatile storage for later execution.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The other devices that connects to local or remote servers to execute the applications are laptops, handheld devices, workstations and wearable devices such as a smart watch.

1. A COMTOOL communication system, the system comprising:
a device with at least one processor coupled to a clock, memory controller and random access memory that processes incoming and outgoing data and issues instructions to communicate through a network and transmit said instructions to a server to execute, wherein the network is at least one of wired, wireless, or a combination thereof, the device having network connectivity further comprising a visual display, an operating system, and processing capabilities for installing a communication system;
a create account mechanism that facilitates user account creation and management on a mobile phone, tablet, computer and television set;
a television remote control with a selector button that confirms a previously selected action, for example, pausing a video selects a subscribe button that is displayed on a television screen and confirmed by the television remote control selector button,
an algorithm that displays a video playback control meter and executes commands;
a plurality of interfaces invoked by algorithms that interact with a database and files system utilized for data storage; and at least one server with a processor coupled to server memory that stores at least one database and computer executable instructions that when executed by the processor causes the server to launch modules in an application with embedded queries to retrieve data from the database or files, process and save incoming data,
wherein the system simplifies a process of electronic communication by integrating functions of various communication applications making them accessible from one interface over wired and wireless networks, and by forwarding, pausing and rewinding videos in playback mode on the television screen utilizing the television remote control.

2. The system of claim 1, further comprising an algorithm that controls account creation, authentication and management wherein the create account mechanism facilitates creating of a user account, wherein the algorithm identifies users by a user type and transmits instructions to a server processor to test account completion steps in the database and authenticates a user to display a menu based on user type that includes basic, commercial admin and staff with specific features,
wherein an authenticated commercial account provides an administrative menu interface that accepts account requests, disables or deletes an existing user account, uploads content and adds a financial account, and wherein selecting a disable feature button for a specific feature, a corresponding app which implements this feature disables the feature in the comtool communication system.

3. The system of claim 2, wherein a commercial user in the Comtool communication system creates an admin account for managing staff, and
staff submits a create account request to the admin account via a form in the application,
sending a name, an email and a phone number to create a partial account, wherein the admin account views the request through the admin menu,
completes the account by specifying a user title, and
submitting a confirmation to the server to update the partial account in a database with a users entity, wherein the staff and admin are notified that the requested account is completed by at least one of: email, text, communication message, notification, alert, prompt, or message.

4. The system of claim 1, wherein the device is configured to implement the COMTOOL communication system; and
the device is at least one of: a mobile phone, tablet, laptop, handheld device, smart phone, a workstation, a local or remote server, or a wearable device such as a smartwatch, having a mobile interface that transmits instructions to the processor and invokes the algorithms and interfaces installed in memory of the device that when executed, wirelessly transmits instructions to a server and retrieves data pertaining to content provider channels, wherein a mobile user adds channels of interest to a channel list in the mobile app and sorts the channels by category and country.

5. The system of claim 1, further comprising a method for creating accounts, authenticating users and managing user accounts, which includes adding user account requests, deleting users from the account or group and displaying videos for non-subscribers, wherein a video playback application that uploads videos and caches video id, video source channel id and user id or device id that are utilized during video playback to add a subscription to a video source channel associated with the video source channel id, and
a subscribed user creates a favorites DVR that is located on a server and accessible by authentication.

6. The system of claim 5, wherein the device is a television set wirelessly coupled to the television remote control that submits instructions to the television with an operating system in memory coupled to at least one processor, the instructions transmitted to a server via a network, retrieves data from the server which data is displayed on the television screen, and wherein the television set comprises an initial interface with a designated window for displaying ads from the server; a method for creating user accounts, authenticating users and managing the user accounts: providing a basic menu with options to logging in, or creating an account, or resetting a password or displaying videos, wherein the user logging in by entering a user id in form of a phone number or email and a password and the method authenticating the user, and displaying a menu; having a button link on a main interface for creating a commercial account after the user is authenticated and the main menu having another button link for requesting an account as staff to a commercial account,

7. The system of claim 6, wherein the television remote control provides a selector button and a subscribe button which is a hardware key, and when pressed, transmits instructions to the television and video playback application to request for a subscription to a currently playing video source channel, wherein the video playback application extracts the playing video id, video source channel id and user id from cache memory and transmits a request to the server to add the video source channel to the user account and device; wherein the subscribe button displays on the television screen along with words as instructions to users during a video pause, and at end of video playback, wherein a reader in the video playback application that reads instructions from the television remote control, executes a delay for instructions similar to double press from the television remote control, and wherein the system displays words as instructions to users on a television screen on how to use a television remote control.

8. The system of claim 6, wherein the algorithm that displays the video playback control meter is configured to:
display a video playback control meter and execute commands on a television set,
take in as parameters a video id, a video length and related data to display,
convert the video length to a number of seconds, wherein the algorithm assigns the number of seconds in video length (VL) of the uploaded video to number of segments (NS) wherein each second is assigned one segment in the number of segments in the video playback control meter,
advance a playing video to one segment for every second that elapses,
draw the segments in a single row of a table as table cells,
when uploading videos, providing users with:
a text field to enter a message to display during video playback,
another text field where a user enters a time at which the user want the message to display based on the video length a video plays,
receiving user input specifying:
when the message shows, and
the location on the video playback screen where the message displays; and the video playback application in the television set reads elapsed time and extracts a message parameter from a session cache and displays the message on a television screen at a specified time as a uniform resource locator, advertisement or other message.

9. The system of claim 1, further comprising a system simplification of the process of electronic communication configured to integrate functions of various communication applications further comprises:
integrating at least one of a calendar app, a phone app, a video chart app, a video playback app, a religious and political groups app, a forum app, a messaging app and a photo album app making them accessible from one user interface wherein access to the apps is provided individually utilizing a user group for each app; and
providing, by a settings UI of the COMTOOL communication system utilized to configure independent apps, a setting for default language wherein users selects a language to be used as the default in the system.

10. The system of claim 9, wherein an add contact button of a Contacts UI adds a contact to a specific application including the album and calendar applications, and pressing or clicking one of the button links such as calendar button, provides a button to request access to that service so that the user can interact with that particular contact on the calendar, wherein access rights to the calendar are divided into read, read/write and edit.

11. The system of claim 3, wherein the users entity in the database is characterized by attributes security UserID and security UserID Color, configured to secure user posts against imposters that create accounts to mimic existing accounts that are synonymous;
wherein the UserID and UserID Color prevents imposters by providing a color coding system having one color for all initial users with a given name and a different color for secondary users that have names similar to initial users; and
wherein the color coding system in conjunction with the user ID serves as a visual cue for contacts to recognize that the message posted is not from the original contact but from an imposter.

12. The system of claim 3, wherein an initial interface of the COMTOOL communication system provides a login screen; and
displays a window designated for ads in form of text, video or audio on mobile phones and tablets.

13. The system of claim 2, wherein the algorithm that controls account creation, authentication and management in the Comtool communication system:
is configured to save transaction data on servers,
identifies users by user type and the system shares user postings to social media platforms of different kinds via hypertext transfer protocol links.

14. The system of claim 2, wherein users add posts and videos to favorites by selecting a button link named Add to Favorite which saves author id, wherein the posts and videos added to favorite generates points for the author or video content provider and these points accumulate to elevate the author or video content provider status; wherein the favorite count is shown on the content provider's profile, and wherein the add to favorite button saves a link to the content for the user to view later within a favorite UI.

15. The system of claim 2, wherein the users of the COMTOOL communication system are required to describe graphics to be posted and type of content in the graphics so as to control misinformation, wherein the Comtool communication system provides a platform for communicating, utilizing multiple applications from one system.

16. (canceled)

17. (canceled)

18. A method of forwarding, pausing and rewinding a video in playback mode on a television screen of a Comtool communication system utilizing a television remote control with a selector button and a processor coupled to a memory, the method comprising:
targeting a moving cursor, by the selector button, on a video playback control meter and pausing or restarting to transmit a command as a signal through a remote control transmitter and a television lens wherein the command is converted to a digital instruction that invokes a module to pause or restart a video;
placing a moving cursor on the playback control meter, by a rewind button, a number of segments backwards as instructed to rewind a video;
transmitting a forward command as a signal through the remote control transmitter and television lens, a forward button, for conversion into a digital command that moves the cursor on the video playback control meter a number of segments forwards as instructed to forward the video,
wherein a subscribe button displays on the television screen during a video pause and at end of video playback; and user parameters are cached along with video channel parameters during playback wherein double pressing the selector button on the television remote control, selects the subscribe button on the television screen, and transmits a subscription request to a video source channel sending channel id and user id to subscribe, wherein the subscription instruction is transmitted to a processor and saved to a database in memory of the server.

19. The system of claim 4 wherein the device having a mobile interface allows for navigation to an address by performing at least one of:
determining when a contact's address is in the system, an address command invokes a navigation module that leads the user to the contact's address; and
providing a contacts UI wherein touching a picture or name of a contact displays address of the contact with a navigation button link whereby pressing the navigation button link invokes a navigation module that interact with server based software and positioning nodes on the network connected to, to lead the user to that address.

20. The method of claim 18, wherein the selector button on the television remote control confirms a pause of a video in playback mode and generates segments that represents motion of a marker and portion of the video played; when a video is playing, the video playback control meter (VPCM) is made invisible by giving all elements in the playback meter an opacity of zero or near zero to make the segments transparent and time elapsed during playback is measured in seconds, wherein each second is assigned one segment in the playback meter, and a playing video advances to one segment for every second that elapses, wherein the segments are drawn in a single row as table cells, and wherein the VPCM is floated on top of the video by assigning the VPCM a higher z-index at a time of video pause, forward or rewind.

21. The system of claim 9, wherein the messaging app receives messages from external email clients and sends messages to external email clients by automatically reading email addresses from the contacts or emails addresses manually entered by a user whereby increasing the ease of communication between users and groups of users across platforms.
